(19) United States
(12) Patent Application Publication
(10) Pub. No.: US 2008/0276000 A1
(43) Pub. Date: Nov. 6, 2008

(54) System and Method for Distributing Content via a Shared Network

(75) Inventors: Stefaan Motte, Leuven (BE); Marc Simon Remy Masschelein, Leuven (BE); Tim Froidcoeur, Leuven (BE); Ann De Bolster, Leuven (BE); Bastiaan Fons Joris Van Eeckhoudt, Leuven (BE); Alex De Bruyn, Leuven (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,598

(22) PCT Filed: Jun. 22, 2005
(86) PCT No.: PCT/IB2005/052052

§ 371 Date: Dec. 14, 2006

(30) Foreign Application Priority Data
Jun. 22, 2004 (EP) 04102963.8

(51) Int. Cl. G06F 15/16

(52) U.S. Cl. 709/233

(57) ABSTRACT

Bandwidth use between an access provider system (14) and a user computer (10) is adapted to an amount of subscription quotum that has been used by a subscriber. Quotum use information is representative of an amount of data that has been exchanged between the user computer (10) and an access provider system (14) since a predetermined time point. A request is received for retrieving media information from the network (16) and for rendering that media information at the user computer (10). In response to the request a selection is made between a plurality of versions of the requested media information, dependent on the quotum use information. Different versions require respective different data rates for transmission from the access provider system (14) to the user computer (10). The more quotum has been used, the lower the data rate of the selected version.

The invention relates to a system and method for distributing content via a shared network such as the Internet.

From the publicly available Windows Media™ technologies it is known to provide an “intelligent streaming” feature. With this feature video and/or audio streams (media information) can be received with the highest possible quality over the Internet. A server of a content provider offers different versions of the same media information encoded at different data rates. Each version may be used for transmission of the media information to a client over the Internet. Versions encoded at increasingly higher data rate support increasingly better quality video and/or audio signal rendering but also require increasingly more transmission bandwidth to maintain a continuous signal. In Windows media, the available bandwidth is measured during transmission of the media information and the version of the media data that is used for transmission is adapted according to the measured available bandwidth, so as to ensure that the best rendering quality consistent with the available bandwidth is used.

Internet users typically have access to the Internet through the services of an Internet access provider. Internet access providers offer various kinds of subscriptions to their customers. For example, a subscription may involve monthly fees in proportion to the amount of time that the customer has been connected to the Internet in the previous month, or a fee in proportion to the amount of data downloaded by the customer. Other subscriptions are quota based, involving a basic monthly fee independent of access and a monthly quotum of data (e.g. 10 Gbyte) that can be accessed at no further cost. If the quotum is exceeded additional fees are charged in proportion to the excess, or access is blocked. Other types of subscriptions involve different quota for different time periods e.g. for daytime and night time use.

Effectively, such quota based subscriptions form a mechanism for managing the cable bandwidth of the Internet access provider and the capacity of his access machines. Blocking access if a quotum is exceeded frees bandwidth for other customers whose quota has not been exceeded. The feedback that additional fees are charged if the quotum is exceeded, either with an immediate signal when the quotum has been exceeded or later in the form of a bill, is also intended to reduce bandwidth use, or at least makes it possible to pass the charge for excess bandwidth that the access provider has to buy to provide the requested bandwidth to its customers.

To make effective use of such quota based subscriptions the customer of the access provider could consider reducing the data rate of downloaded media information so as to get access to more media information within the quotum, or, on the contrary, increasing the data rate to ensure high quality rendering if a sufficient amount of quotum is available. However, in practice this is awkward, because it requires monitoring the quotum and choosing between different URL's to select a version of a signal with the desired data rate.

Among others, it is an object of the invention to provide an automated method of making effective use of an access quotum.

According to the invention the amount of transmission quotum that has been used by the user during a subscription period is used to guide selection of the version of requested media information. Requests for media information are translated into requests for selected versions of the media information that require different transmission data rates. When the used amount of quotum indicates that there is a danger of exceeding the quotum, requests for media information are translated in to requests for lower data rate versions of this media information than when the quotum information indicates less risk of exceeding the quotum.

An existing system for selecting versions of the media information dependent on a currently available bandwidth may be adapted for this purpose. Instead of using bandwidth measurements, or in addition to using such measurements, quotum use information is used to guide selection of the version for transmission. Typically, in such a system the server of the content provider stores the different versions of the media information. In this case the selected version is signaled to the server of the content provider and this server selectively transmits the selected version. It may be noted that with selection according to the invention the selected data rate may be much lower than necessary to fit in the available bandwidth. The selection is controlled with quotum information from the access provider (or the user computer).

The quotum use information may be representative of an amount of data that has been exchanged between the user computer and the access provider system, but it may alternatively be representative of an amount of data that has been exchanged between a group of computers containing the user computer and the access provider system. The group of computers may constitute an authorized domain. Some particular architectures of authorized domains have been outlined in international patent application WO 03/098931 (attorney docket PHNL020455), European patent application serial number 03100772.7 (attorney docket PHNL030283), European patent application serial number 03102281.7 (attorney docket PHNL030926), European patent application serial number 04100997.8 (attorney docket PHNL040288) and F. Kamperman and W. Jonker, P. Lenoir, and B. vd Heuvel, Secure content management in authorized domains, Proc. IBC2002, pages 467-475, September 2002. If the group of computers constitute an authorized domain, this has the advantage that data exchanged with either computer of the authorized domain counts against the quotum. This fits in particularly well if the authorized domain is that of an household, and if the quotum is based on a subscription for the household.

In another embodiment a translation computer in the network is used to translate an original version of the media information into the selected version during transmission to the user computer before entering the access provider system. In this case the selection does not affect bandwidth use in the part of the network that transmits the original version, but merely reduces bandwidth use in the part of user computer-access provider apparatus connection that is subject to the quotum.

These and other objects and advantageous aspects will be described by means of non-limitative examples using the following figures.

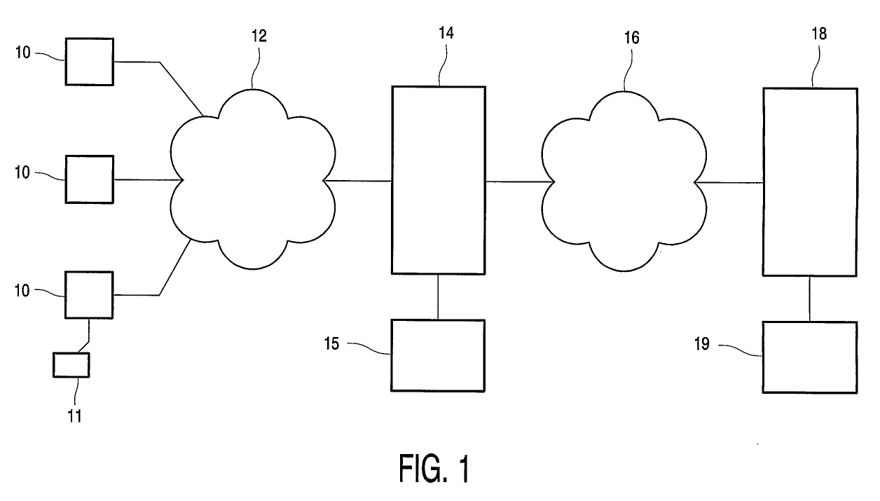

FIG. 1 shows a network system

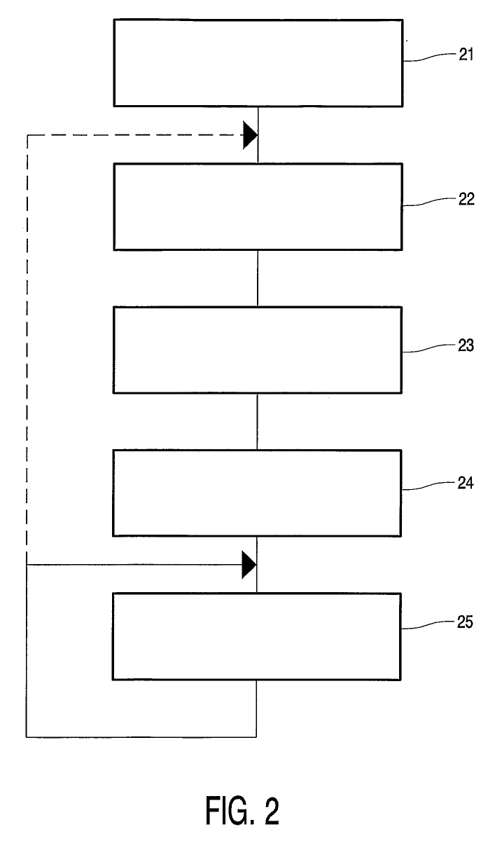

FIG. 2 shows a flowchart of a download process

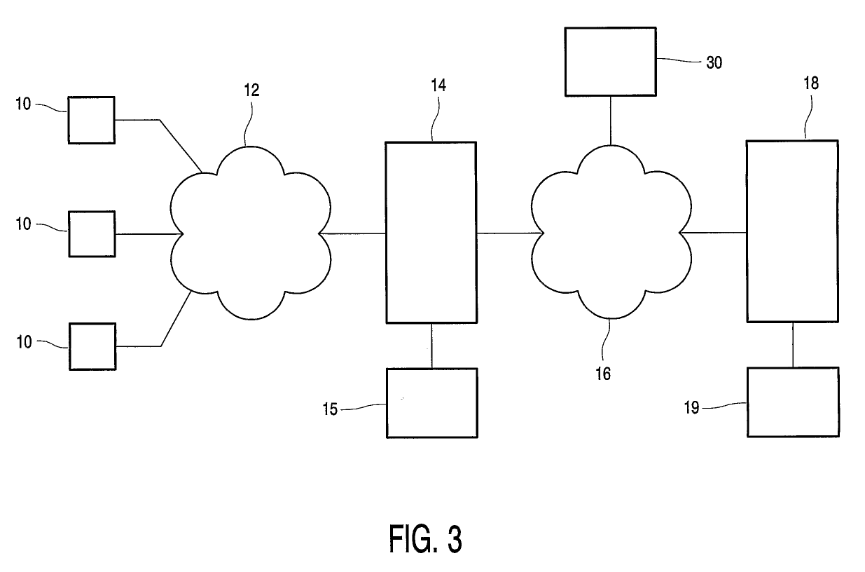

FIG. 3 shows a further network system

FIG. 1 shows a network system comprising a plurality of user computers 10, a first communication network 12, an access provider system 14, a second communication network 16 and a content provider system 18. First communication network 12 is for example a public telephone network, a cable TV network etc. Second communication network 16 contains for example the Internet backbone network. User computers 10 may be general purpose computers, computers incorporated in specific apparatuses (such as CE equipment like television sets, or portable equipment like telephones or personal assistant devices) or computers in a local network. Typically each user computer 10 is provided with an input 11 for receiving commands, such as a keyboard, a mouse, a remote control unit or a touch screen etc. User computers 10 are coupled to access provider system 14 via first communication network 12. Access provider system 14 is coupled to content provider system 18 via second communication network 16. Typically a vast number of different content provider systems is coupled to second communication network 16, but only one is shown for the sake of simplicity. The access provider system 14 is coupled to a quota storage device 15 and the content provider system 18 is coupled to a content storage device 19.

In operation a user selects audio and/or video data (or more generally media information) from content provider system 18 for access, using a user computer 10, typically by clicking a hyperlink in a web page. In response user computer 10 sends a request to access provider system 14 through first communication network 12. Access provider system 14 forwards the request to content provider system 18 via second communication network 16. In response to the forwarded request, content provider system retrieves a version of the selected media information and transmits this version back to user computer 10 as a stream of data via second communication network 16, access provider system 14 and first communication network 12. In a preferred embodiment the version is transmitted in near real time, that is, the rate of transmission is so that the media information can be replayed (the video information being made normally visible and/or the audio information being made normally audible) without having to buffer more than a predetermined amount of data (e.g. for 1 or 10 seconds or a minute of replay) outside content provider system 18.

Content provider system 18 has a plurality of versions of the media information stored in storage device 19. Typically different versions have been obtained by compressing an original version of the media information with a lossy compression algorithm at different compression rates. Each version corresponds to a different data rate (average number of bits per second) that has to be used for transmission to transmit data from the version in near real time. Furthermore, content provider system 18 preferably contains a data base from which URL's (or more generally storage address information) of different versions can be retrieved by specifying a content identifier and a required data rate.

Access provider system 14 maintains quota information for respective subscribers and quotum use information for these subscribers. Each subscriber is associated with a user computer 10 or a group of computers The quotum is a number stored in quota storage device 15. Access provider system 14 keeps track of the amount of data that has been transferred for a subscriber during a subscription period of, say, one month or one week. When a user computer 10 transfers data via access provider system 14 (typically during downloading) access provider system 14 counts the amount of data and increments a quotum use number in proportion to the count. The quotum use number is updated in quota storage device 15. The quotum use number may be used for example to block further transfer to and/or from a user computer 10 once the quotum use number exceeds or equals the quotum, or to throttle down the maximum data rate to and/or from the user computer to a predetermined maximum if the quotum is exceeded, or to prepare a bill for excess data transfer at the end of the subscription period. In an embodiment a plurality of quota may be assigned to a subscriber, for example different quota for upload and download, different quota for different times of day, or different quota for bandwidth from different user computers.

FIG. 2 shown a flow chart of a download process, as executed typically by access provider system 14. In a first step 21 access provider system 14 receives a request to retrieve media information, accompanied for example by an identifier (e.g. a URL) of the requested media information from a user computer 10.

In a second step 22 access provider system 14 accesses quota storage device 15 to determine the quotum use number for the subscriber that uses the requesting user computer 10. In the second step 22 access provider system 14 selects a data rate dependent on the quotum use number. Various selection mechanisms may be used. For example a number of ranges of quotum use number values may be defined, each range being associated with a different data rate that is selected when the quotum use number is in that range. The ranges may be predetermined, or their borders may be set dependent on the fraction of the subscription period that has elapsed since the start of the subscription period and/or in proportion to the quotum number for the subscriber.

In a third step 23 access provider system 14 accesses the database of content provider system 18 using the identifier of the media information and the selected data rate to determine the address (URL) of the version of the media data with the selected data rate or a closest data rate near or below the selected data rate. In a fourth step 24 access provider system 14 sends a command to content provider system 18 to retrieve and transmit the selected version of the media data. In a fifth step 25 access provider system 14 receives data from that version of the media information and forwards it to user computer 10 via first communication network 12. Fifth step 25 is repeated until all the media information has been sent, or the user computer 10 sends a command to terminate transmission. During fifth step 25 the quotum use number is updated. Optionally fifth step 25 is followed by second step, to adjust the data rate in response to changes in the quotum use.

As an alternative user computer 10 may send repeated requests for successive parts of the media information. In this case access provider system 14 may select the data rate and corresponding version for each request, or the result of an initial selection that has been made for the first part may be used for all subsequent parts.

It should be understood that it is not necessary that the steps of the process of FIG. 2 are all executed by access provider system 14. For example, the rate selection step and the step of selecting an address (URL) of the required version may also be executed by user computer 10. In this case, user computer 10 may retrieve the quotum use number from access provider system 14, or user computer 10 maintain a shadow number by counting the amount of exchanged data locally. As another example, the rate selection step and the step of selecting an address (URL) of the required version may be executed by a separate service provider. In this case, the service provider 10 may retrieve the quotum use number from access provider system 14, or maintain a shadow number by counting the amount of exchanged data.

Typically, the described steps will be executed by one or more suitably programmed programmable computers. A program or programs for these computers may be provided in a computer program product, e.g. loaded in a (flash) memory, on an (optical) disk, as an Internet signal etc. Dependent on where the various functions are executed such a computer program product may be used in user computer 10, access provider system 14 or in a service provider system (e.g. 30 in FIG. 3), or in content provider system 18, which then also functions as a service provider system. However, instead of programmable computers hardwired devices may be used to perform the functions.

FIG. 3 illustrates an embodiment wherein a service provider system 30 coupled to second communication network 16 is used. In one embodiment service provider system 30 is used to perform the steps of version selection. In this embodiment user computer 10 first accesses the service provider system to receive the URL of the selected version before accessing content provider system 18 directly

In another embodiment service provider system 30 may be used to translate an original version of the requested media data into a version with a selected data rate. This may be done in combination with selection of the data rate at service provider system 30 or at access provider system 14 or at user computer 10. Once the data rate has been selected a command is sent to content provider system 18 to stream the original version of the media information to service provider system 30. Service provider system 30 uses lossy compression to compress the original version to a version with a selected data rate. Service provider system 30 may use any lossy compression technique that produces the required data rate; such techniques are known per se. Service provider system 30 forwards the compressed version of the media information to access provider system 14, form where it is forwarded to user computer 10.

Various refinements may be applied to the selection of the data rate. For example, a software interface may be provided to overrule automatic data rate selection from user computer 10. In this way a user may select a high quality version of the media information if necessary. As another example, a software interface may be provided with which a user specifies a list of addresses to which automatic data rate selection should not be applied. When the data rate is selected in second step 22 of FIG. 2 this list is consulted and compared with the identifier of the requested media information to determine whether a quotum use dependent data rate or a predetermined (e.g. maximum data rate) should be selected. Instead, a list may be defined of media information to which automatic data rate selection should be applied, the automatic data rate selection being applied to no other media information.

In a further embodiment the quota may be refined, e.g. by defining different quota for transmission during certain periods of each day and/or certain weekdays, or defining a quotum only for certain periods of each day and/or certain weekdays. In this case, the data rate selection is made dependent on the quotum, if any, and the quotum use for the period of the day and/or the weekday at which the data is transmitted.

Quotum use dependent data rate selection is preferably implemented using a program of instructions executed by a programmable computer. Such programs may be loaded into the relevant computer from a computer program product such as a disk or an Internet signal. However, without deviating from the invention dedicated hardware may be used for quotum use dependent data rate selection.

1. A method of adapting use of bandwidth through an access provider system (14) that couples a user computer (10) to a network (16), the method comprising
maintaining quotum use information representative of an amount of data that has been exchanged between the user computer (10) and the access provider system (14) since a predetermined time point;
receiving a request for a media information transmission from the access provider system (14) to the user computer (10);
selecting between a plurality of versions of the requested media information dependent on the quotum use information, different ones of the versions requiring respective different data rates for transmission from the access provider system (14) to the user computer (10), the higher the amount of data represented by the quotum use information, the lower the data rate of the selected version;
transmitting the selected version of the media information from the access provider system (14) to the user computer (10).

2. A method of adapting bandwidth use according to claim 1, wherein a content provider computer (18) is coupled to the network (16), the content provider computer (18) storing the plurality of versions of the media information, the method comprising forming a transmission request signal for the content provider computer (18), the transmission request signal specifying the version from which data must be transmitted, the transmission request signal being formed dependent on the quotum use information.

3. A method of adapting bandwidth use according to claim 1, wherein the network contains a translation computer (30) arranged to translate an original version of the media information into a selectable one of the versions of the media information, the method comprising
setting up a transmission of the original version through the network to the translation computer (30);
commanding the translation computer (30) to translate the original version into the selected version;
setting up a transmission of the selected version from the translation computer (30) to the access provider system (14).

4. A method of adapting bandwidth use according to claim 1, wherein the network contains a plurality of user computers (10) coupled to the network via the access provider system (14), the method comprising
assigning quota to the user computers (10) individually or to respective groups of computers, each containing a user computer, at least two user computers (10) or two groups containing the at least two user computers (10) respectively, being assigned mutually different quota for a same use period;
maintaining quotum use information for each of the user computers (10) or groups;
said selecting depending on the quota left for each user computer (10) or group after deduction of the used quotum, so that if said at least two user computers (10) or groups have exchanged a same amount of data since the predetermined time point, a higher data rate version is selected for the user computer (10) with the higher quotum than for the user computer (10) with the lower quotum.

5. A method of adapting bandwidth use according to claim 1, wherein
the quotum use information is maintained selectively for data exchange during predefined daily repeating time interval and/or at predefined weekdays since the predetermined time point;
the selection between a plurality of versions of the requested media information is made dependent on the quotum use information and the daily time interval and/or at weekday in which the media information is to be transmitted.

6. A method of adapting bandwidth use according to claim 1, comprising comparing the request with a list of media information identifiers to determine whether to apply the selection dependent on the quotum use information or to apply a predetermined selection.

7. A method of adapting bandwidth use according to claim 1, wherein respective data rates are associated with respective ranges of quotum use information values, the version being selected according to the data range in which quotum use information lies.

8. A network access system comprising an access provider system (14) coupled to a network (16) and a user computer (10) coupled to the network via the access provider system (14), the network access system comprising
a quotum use information maintenance unit (10, 15 or 30) arranged to maintain quotum use information representative of an amount of data that has been exchanged between the user computer and the access provider system (14) since a predetermined time point;
a data rate selection unit arranged (10, 14 or 30) to control which one of a plurality of versions of requested media information will be transmitted from the access provider system (14) to the user computer (10), different ones of the versions requiring respective different data rates for transmission from the access provider system (14) to the user computer (10), the version being selected dependent on the quotum use information, the higher the amount of data represented by the quotum use information, the lower the data rate of the selected version.

9. A network access system according to claim 8, wherein the access provider system (14) is arranged to throttle down a bandwidth for transmission to the user computer (10) when the amount of data that has been exchanged since the predetermined time point exceeds a predetermined threshold.

10. A network access system according to claim 8, wherein the access provider system (10) has a billing component that is arranged to accumulate surcharge information starting once the amount of data that has been exchanged since the predetermined time point exceeds a predetermined threshold.

11. A network access system according to claim 8, wherein the quotum use information maintenance unit (15) and the data rate selection unit are located in the access provider system (14).

12. A network access system according to claim 8, wherein the quotum use information maintenance unit and the data rate selection unit are located in the user computer (10).

13. A network access system according to claim 8, wherein the data rate selection unit is located in a service provider system (30) connected to the network (16).

14. A network access system according to claim 8, wherein the user computer (10) is arranged to send requests to load data from a content provider system (18) to a service provider system (30), the service provider system being arranged to select the data rate and to route the selected version to the access provider system (14).

15. An access provider system (14) comprising a first connection for connecting to a network (16) and a second connection for connecting to at least one user computer (10); the access provider system being arranged to
receive a request for sending media information from the network (16) to the user computer;
obtain quotum use information representative of an amount of data that has been exchanged between the user computer and the access provider system (14) since a predetermined time point;
select which one of a plurality of versions of the requested media information will be sent to the user computer (10) from the access provider system (14), different ones of the versions requiring respective different data rates for transmission from the access provider system (14) to the user computer (10), the version being selected dependent on the quotum use information, the higher the amount of data represented by the quotum use information, the lower the data rate of the selected version;
cause the selected version to be sent via the connection to the user computer (10).

16. A user computer (10) comprising
a connection for connecting to a network (16) via an access provider system (14);
an input for receiving a request for a media information transmission from the network (16) via the access provider system (14); the user computer being arranged to
obtain quotum use information representative of an amount of data that has been exchanged between the user computer and the access provider system (14) since a predetermined time point;
select which one of a plurality of versions of the requested media information will be sent to the user computer (10) from the access provider system (14), different ones of the versions requiring respective different data rates for transmission from the access provider system (14) to the user computer (10), the version being selected dependent on the quotum use information, the higher the amount of data represented by the quotum use information, the lower the data rate of the selected version;
send a signal requesting transmission of the selected version.

17. A service provider system comprising
a connection for connecting to a network (16) for receiving a request for transmission of media information via the network (16) to a user computer (10) via the access provider system (14); service provider system being arranged to
obtain quotum use information representative of an amount of data that has been exchanged between the user computer and the access provider system (14) since a predetermined time point;
select which one of a plurality of versions of the requested media information will be sent to the user computer (10) from the access provider system (14), different ones of the versions requiring respective different data rates for transmission from the access provider system (14) to the user computer (10), the version being selected dependent on the quotum use information, the higher the amount of data represented by the quotum use information, the lower the data rate of the selected version;
cause the selected version to be sent to the user computer (10) via the access provider system (14).

18. A computer program product comprising instructions which when executed by a programmable computer cause the programmable computer to
receive a request for transmission of media information from a network (16) to a user computer (10) via an access provider system (14);
obtain quotum use information representative of an amount of data that has been exchanged between the user computer and the access provider system (14) since a predetermined time point;
select which one of a plurality of versions of the requested media information will be transmitted from the access provider system (14) to the user computer (10), different ones of the versions requiring respective different data rates for transmission from the access provider system (14) to the user computer (10), the version being selected dependent on the quotum use information, the higher the amount of data represented by the quotum use information, the lower the data rate of the selected version;
cause the selected version to be sent to the user computer (10) via the access provider system (14).
